(19) United States
(12) Patent Application Publication
(10) Pub. No.: US 2015/0327247 A1
(43) Pub. Date: Nov. 12, 2015

(54) CHANNEL QUALITY INDICATION FOR FALLBACK TRANSMISSION MODE OVER NEW CARRIER TYPE

(71) Applicant: INTEL IP CORPORATION, Santa Clara, CA (US)

(72) Inventors: Xiaogang Chen, Beijing (CN); Yuan Zhu, Beijing (CN); Seunghee Han, Cupertino, CA (US); Shafi Bashar, Santa Clara, CA (US); Jong-Kae Fwu, Sunnyvale, CA (US)

(21) Appl. No.: 14/652,600

(22) PCT Filed: Dec. 17, 2013
(86) PCT No.: PCT/US13/75849

§ 371 Date: Jun. 16, 2015

Related U.S. Application Data
(60) Provisional application No. 61/753,914, filed on Jan. 17, 2013.

(51) Int. Cl. H04W 72/04; H04B 7/04; H04W 72/02; H04L 5/00

(52) U.S. Cl. CPC H04W 72/0413; H04L 5/0057; H04L 5/0051; H04B 7/0417; H04B 7/0456; H04W 72/02

(57) ABSTRACT

A new carrier type (NCT) has been developed for LTE in order to reduce the overhead associated with cell-specific reference signals (CRS) and control signaling via the PDCCH. The NCT is an LTE carrier with minimized control channel overhead and cell-specific reference signals. Described herein are techniques where, upon receiving a PDSCH grant from a eNB using DCI format 1A to indicate a fallback transmission mode, a UE transmits a CQI to the eNB based upon CSI-RS resources contained in the NCT.

### PRIORITY CLAIM

This application claims the benefit of priority to U.S. Provisional Patent Application Ser. No. 61/753,914, filed Jan. 17, 2013, which is incorporated herein by reference in its entirety.

### TECHNICAL FIELD

Embodiments described herein relate generally to wireless networks and communications systems.

### BACKGROUND

In LTE (Long Term Evolution) cellular systems, as set forth in the LTE specifications of the 3rd Generation Partnership Project (3GPP), terminals (where a terminal is referred to in LTE systems as user equipment or UE) connect to a base station (referred in LTE systems as an evolved Node B or eNB) that provides connectivity for the UE to other network entities of the LTE system that connect to an external network such as the internet

A new carrier type (NCT) has been developed for LTE in order to reduce the overhead associated with cell-specific reference signals (CRS) and control signaling via the PDCCH. The NCT may, in some situations, use only the EPDCCH and not the PDCCH for downlink control signaling. The NCT is an LTE carrier with minimized control channel overhead and cell-specific reference signals. The NCT is intended to enhance spectral efficiency, increase spectrum flexibility, and reduce energy consumption. As described below, problems may arise with respect to the reporting of channel state information by a UE in certain situations.

### BRIEF DESCRIPTION OF THE DRAWINGS

FIG. 1 illustrates a UE and an eNB in accordance with some embodiments.

FIG. 2 illustrates a method performed by the UE to calculate a channel quality indication in a fallback transmission mode using the NCT.

### DETAILED DESCRIPTION

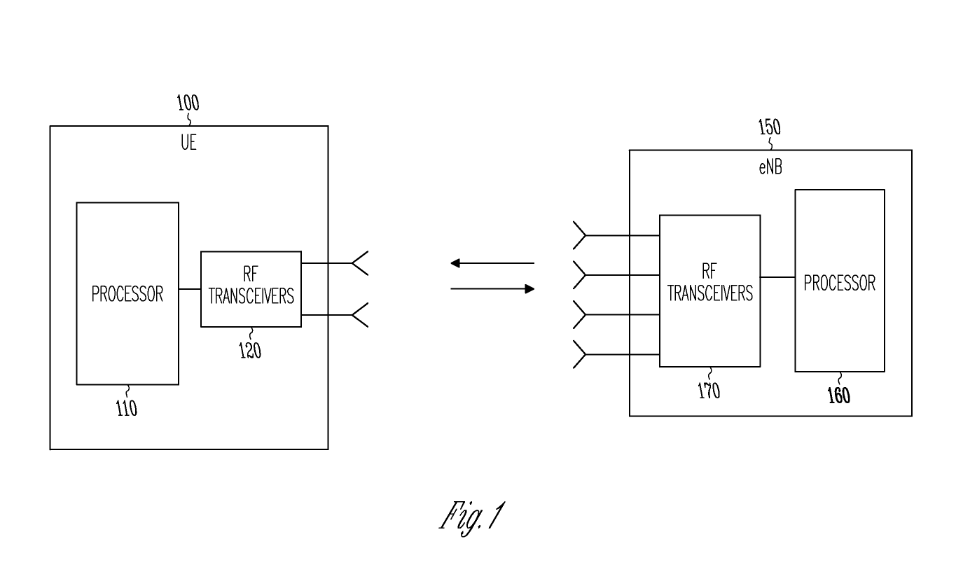

FIG. 1 shows an example of a UE 100 and an eNB 150. The UE and eNB incorporate processing circuitries 110 and 160, respectively. The processing circuitry 110 in the UE is interfaced to a plurality of RF transceivers 120 that are each connected to one of a plurality of antennas 130. The processing circuitry 160 in the eNB is interfaced to a plurality of RF transceivers 170 that are each connected to one of a plurality of antennas 180. The illustrated components are intended to represent any type of hardware/software configuration for providing an LTE air interface and performing the processing functions as described herein.

The physical layer of LTE is based upon orthogonal frequency division multiplexing (OFDM) for the downlink and a related technique, single carrier frequency division multiplexing (SC-FDM), for the uplink. In OFDM/SC-FDM, complex modulation symbols according to a modulation scheme such as QAM (quadrature amplitude modulation) are each individually mapped to a particular OFDM/SC-FDM subcarrier transmitted during an OFDM/SC-FDM symbol, referred to as a resource element (RE). An RE is the smallest physical resource in LTE. LTE also provides for MIMO (multi-input multi-output) operation where multiple layers of data are transmitted and received by multiple antennas and where each of the complex modulation symbols is mapped into one of the multiple transmission layers and then mapped to a particular antenna port. Each RE is then uniquely identified by the antenna port, sub-carrier position, and OFDM symbol index within a radio frame as explained below.

A physical channel corresponds to the set of time-frequency resources used for transmission of a particular transport channel, and each transport channel is mapped to a corresponding physical channel. There are also physical control channels without a corresponding transport channel that are needed for supporting the transmission of the downlink and uplink transport channels. These include the physical downlink control channel (PDCCH) and the enhanced physical downlink control channel (EPDCCH), by which the eNB transmits downlink control information (DCI) to the UE, and the physical uplink control channel (PUCCH) that carries uplink control information (UCI) from the UE to the eNB. Insofar as is relevant to the present disclosure, the DCI carried by the PDCCH or EPDCCH may include scheduling information that allocates uplink and downlink resources to the UE.

Transmission modes correspond to different multi-antenna transmission schemes employed by the eNB to transmit to a UE such as single-antenna transmission, transmit diversity, beam-forming, and spatial multiplexing. Transmission modes are configured by RRC signaling. There are currently ten different transmission modes defined for LTE that differ in terms of the antenna transmission scheme and also as to which reference signals are assumed to be used for demodulation (i.e., cell-specific reference signals or demodulation reference signals, CRS or DMRS, respectively) by the terminal and as to how CSI (channel state information) is acquired by the terminal and fed back to the network. As described above, the downlink scheduling assignments are transmitted as part of the DCI on the PDCCH or EPDCCH. Downlink scheduling assignments are valid for the same subframe in which they are transmitted. The scheduling assignments use one of the DCI formats 1, 1A, 1B, 1C, 1D, 2, 2A, 2B, 2C, or 2D, and the DCI formats used depend on the transmission mode configured.

In order to assist the eNB in making scheduling and configuration decisions, a UE is configured to report channel state information (CSI) back to the eNB in the form of CSI reports. A CSI report contains a channel quality indication (CQI) and may also contain a precoder matrix indication (PMI) and a rank indication (RI). The CQI represents the highest modulation-and-coding scheme that, if used, would mean a downlink data transmission using the recommended RI and PMI, if present, would be received with a block-error probability of at most 10%. The RI provides a recommendation on the transmission rank to use or, expressed differently, the number of layers that should preferably be used for downlink data transmission to the terminal. The PMI indicating a preferred antenna precoder to use for downlink transmission.

As noted above, the new carrier type (NCT) was developed in order to reduce the overhead associated with cell-specific reference signals (CRS) and control signaling via the PDCCH. The NCT may, in some situations, use only the EPDCCH and not the PDCCH for downlink control signaling. The NCT also minimizes or eliminates CRSs and contains demodulation reference signals (DMRS) for demodulation and channel state information reference signals (CSI) for channel state reporting.

Transmission mode 9 corresponds to spatial multiplexing with demodulation by DMRS and uses DCI format 2C. When channel conditions are no longer adequate to support transmission 9, the eNB may signal the UE to switch to a more robust transmit diversity mode (transmission mode 2) by transmitting a downlink scheduling assignment using DCI format 1A. Transmit diversity thus serves as a fallback mode in this situation.

A UE may receive downlink scheduling assignments via DCI format 2C to indicate transmission mode 9 spatial multiplexing and also be configured to report to the eNB channel state information (CSI) that includes a channel quality indication (CQI) but includes neither a precoding matrix indication (PMI) nor a rank indication (RI). If the UE should then receive, a format 1A DCI downlink scheduling grant, the current LTE specifications dictate that the UE should assume the downlink data will be transmitted using transmit diversity and also that CSI reports are to be based upon CRS if no PMI or RI reporting is configured. If PDSCH transmissions between eNB and the UE are on the NCT, however, this causes a problem due to the low density of CRS signals in the NCT. A solution to this problem is for the UE, upon receiving a PDSCH grant from the eNB using DCI format 1A to indicate a fallback transmission mode to transmit a CQI to the eNB based upon CSI-RS (channel state information reference signal) resources contained in the NCT.

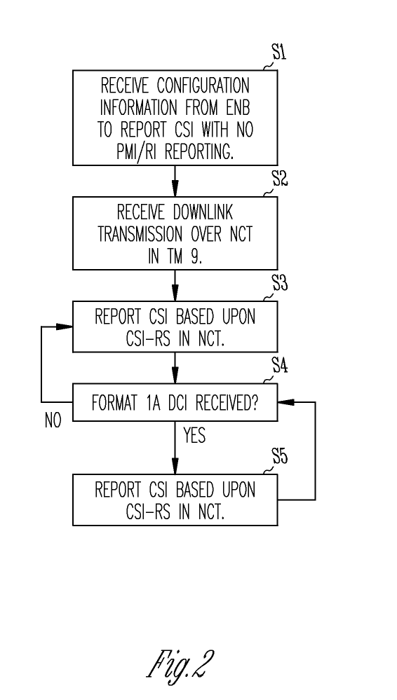

FIG. 2 illustrates a method performed by the UE in carrying out the CSI reporting as just described. At stage S1, the UE receives configuration instructions from the UE to report CSI with no PMI or RI. At stage S2, the UE receives downlink transmissions from the eNB in transmission mode 9 and reports CSI based upon CSI-RS at stage S3. At stage S4, the UE checks if a format 1A DCI has been received. If not, the UE continues back to stage 3 for CSI reporting. If a format 1A DCI has been received, indicating a transition to the fallback transmission mode for the NCT, the UE reports CSI-RS based upon CSI-RS contained in the NCT at stage 5 and then continues back to stage S4. Note that the CSI-RS-based reporting of CSI at stage S3 assumes DCI format 2C for downlink transmissions, while the CSI-RS-based reporting of CSI at stage S5 assumes DCI format 1A for downlink transmissions.

Another problem with the NCT in the fallback mode signaled by DCI format 1A is that, rather than transmit diversity, PDSCH transmissions are over a single DMRS (demodulation reference signal) port. In one embodiment, the UE may therefore be configured to, for purposes of computing the CQI during the fallback mode if the number of antenna ports of the associated CSI-RS resource is one, assume that PDSCH transmissions are on a single DMRS port with the channel on the DMRS port being inferred from the channel on antenna port {15} of the associated CSI-RS resource, assume that PDSCH transmissions are received from the eNB using a transmit diversity transmission mode where the channels of the transmit diversity transmission mode are inferred from the channels on antenna ports {15, 16} of the associated CSI-RS resource, and/or assume that PDSCH transmissions are received from the eNB using a transmit diversity transmission mode where the channels of the transmit diversity transmission mode on antenna ports {0, 1, 2, 3} are inferred from the channels on antenna ports {15, 16, 17, 18} of the associated CSI-RS resource.

When the UE assumes that transmit diversity is being used to transmit the PDSCH over the NCT in the fallback mode, this may lead to some degree of error in the CQI calculation since the PDSCH is actually being transmitted over a single DMRS port. To deal with this problem, the UE may be configured to, for purposes of computing the CQI during the fallback mode, assume that PDSCH transmissions received from the eNB on the single DMRS port are equivalent to corresponding symbols transmitted on antenna ports {15, . . . 14+P}, as given by:

$$[ \begin{matrix}{y}^{( 15 )} ( i ) \\ ⋮ \\ {y}^{( 14 + P )} ( i )\end{matrix} ] = W ( i ) x ( i ) ,$$

where modulation symbols d^{(q)}(0), . . . , d^{(q)} (M_{symbo}^{(q)}−1) for codeword q are mapped onto the layers x(i)=[x⁽⁰⁾(i) . . . x^{(ν-1)}(i)]^{T}, i=0, 1, . . . , M_{symb}^{layer}−1, where ν is the number of layers and M_{symb}^{layer} is the number of modulation symbols per layer, Pε{1,2,4,8} is the number of antenna ports of the associated CSI-RS resource, and W(i) is a precoding matrix. If P=1, W(i) may be set equal to 1. If P>1, W(i) may be a precoding matrix selected by the UE or may be a predefined precoding matrix.

### Additional Notes and Examples

In Example 1, a method for operating a user equipment (UE) in an LTE (Long Term Evolution) network, comprises: communicating with an evolved Node B (eNB) over a New Carrier Type (NCT), wherein the NCT has a reduced density of cell-specific reference signals (CRSs) as compared with a legacy carrier; receiving grants of physical downlink shared channel (PDSCH) resources via control channel signaling with DCI (downlink control information) format 2C where the PDSCH grant may be received over an EPDCCH or a PDCCH; reporting to the eNB channel state information (CSI) that includes a channel quality indication (CQI) but includes neither a precoding matrix indication (PMI) nor a rank indication (RI); and upon receiving a PDSCH grant from the eNB using DCI format 1A to indicate a fallback transmission mode with transmission of the PDSCH over a single DMRS (demodulation reference signal) port, transmitting a CQI to the eNB based upon CSI-RS (channel state information reference signal) resources contained in the NCT.

In Example 2 the subject matter of example 1 may optionally include, for purposes of computing the CQI during the fallback mode if the number of antenna ports of the associated CSI-RS resource is one, assuming that PDSCH transmissions are on a single DMRS port with the channel on the DMRS port being inferred from the channel on antenna port {15} of the associated CSI-RS resource.

In Example 3 the subject matter of example 1 may optionally include, for purposes of computing the CQI during the fallback mode if the number of antenna ports of the associated CSI-RS resource is two, assuming that PDSCH transmissions are received from the eNB using a transmit diversity transmission mode where the channels of the transmit diversity transmission mode are inferred from the channels on antenna ports {15, 16} of the associated CSI-RS resource.

In Example 4 the subject matter of example 1 may optionally include, for purposes of computing the CQI during the fallback mode if the number of antenna ports of the associated CSI-RS resource is four, assuming that PDSCH transmissions are received from the eNB using a transmit diversity transmission mode where the channels of the transmit diversity transmission mode on antenna ports {0, 1, 2, 3} are inferred from the channels on antenna ports {15, 16, 17, 18} of the associated CSI-RS resource.

In Example 5 the subject matter of example 1 may optionally include, for purposes of computing the CQI during the fallback mode, assuming that PDSCH transmissions received from the eNB on the single DMRS port are equivalent to corresponding symbols transmitted on antenna ports {15, . . . 14+P}, as given by

$$[ \begin{matrix}{y}^{( 15 )} ( i ) \\ ⋮ \\ {y}^{( 14 + P )} ( i )\end{matrix} ] = W ( i ) x ( i ) ,$$

where modulation symbols d^{(q)}(0), . . . , d^{(q)}(M_{symb}^{(q)}−1) for codeword q are mapped onto the layers x(i)=)[x⁽⁰⁾(i) . . . x^{(ν-1)}(i)]^{T}, i=0, 1, . . . , M_{symb}^{layer}−1, where ν is the number of layers and M_{symb}^{layer} is the number of modulation symbols per layer, Pε{1,2,4,8} is the number of antenna ports of the associated CSI-RS resource, and W(i) is a precoding matrix.

In Example 6 the subject matter of example 5 may optionally include wherein, if P=1, W(i)=1.

In Example 7 the subject matter of example 5 may optionally include wherein, if P>1, W(i) is a precoding matrix selected by the UE.

In Example 8 the subject matter of example 5 may optionally include wherein, if P>1, W(i) is a predefined precoding matrix.

In Example 9, a user equipment (UE) for operating in an LTE (Long Term Evolution) network, comprises: processing circuitry and a radio interface for communicating with an evolved Node B (eNB) wherein the processing circuitry is to perform any of the methods of Examples 1 through 8.

In Example 10, an evolved Node B (eNB) for operating in an LTE (Long Term Evolution) network, comprises: processing circuitry and a radio interface for communicating with a user equipment (UE), wherein the processing circuitry is to: communicate with the UE over a New Carrier Type (NCT), wherein the NCT has a reduced density of cell-specific reference signals (CRSs) as compared with a legacy carrier; transmit grants of physical downlink shared channel (PDSCH) resources via control channel signaling with DCI (downlink control information) format 2C; configure the UE to report channel state information (CSI) that includes a channel quality indication (CQI) but includes neither a precoding matrix indication (PMI) nor a rank indication (RI); if a PDSCH grant is transmitted to the UE using DCI format 1A to indicate a fallback transmission mode, transmit the PDSCH over a single DMRS (demodulation reference signal) port, and assume that the CQI received from the UE is based upon CSI-RS (channel state information reference signal) resources contained in the NCT.

In Example 11, the subject matter of Example 10 may optionally include wherein the processing circuitry is to assume that the UE, for purposes of computing the CQI during the fallback mode, performs any of the methods of Examples 2 through 8.

In Example 12, a computer-readable medium contains instruction for performing any of the methods of Examples 1 through 8.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the invention is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11-2007 and/or 802.11(n) standards and/or proposed specifications for WLANs, although the scope of the invention is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the invention is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1.-24. (canceled)

25. A method for operating a user equipment (UE) in an LTE (Long Term Evolution) network, comprising:
communicating with an evolved Node B (eNB) over a New Carrier Type (NCT), wherein the NCT has a reduced density of cell-specific reference signals (CRSs) as compared with a legacy carrier;
receiving grants of physical downlink shared channel (PDSCH) resources via control channel signaling with DCI (downlink control information) format 2C;
reporting to the eNB channel state information (CSI) that includes a channel quality indication (CQI) but includes neither a precoding matrix indication (PMI) nor a rank indication (RI); and
upon receiving a PDSCH grant from the eNB using DCI format 1A to indicate a fallback transmission mode with transmission of the PDSCH over a single DMRS (demodulation reference signal) port, transmitting a CQI to the eNB based upon CSI-RS (channel state information reference signal) resources contained in the NCT.

26. The method of claim 25 further comprising, for purposes of computing the CQI during the fallback mode if the number of antenna ports of the associated CSI-RS resource is one, assuming that PDSCH transmissions are on a single DMRS port with the channel on the DMRS port being inferred from the channel on antenna port {15} of the associated CSI-RS resource.

27. The method of claim 25 further comprising, for purposes of computing the CQI during the fallback mode if the number of antenna ports of the associated CSI-RS resource is two, assuming that PDSCH transmissions are received from the eNB using a transmit diversity transmission mode where the channels of the transmit diversity transmission mode are inferred from the channels on antenna ports {15, 16} of the associated CSI-RS resource.

28. The method of claim 25 further comprising, for purposes of computing the CQI during the fallback mode if the number of antenna ports of the associated CSI-RS resource is four, assuming that PDSCH transmissions are received from the eNB using a transmit diversity transmission mode where the channels of the transmit diversity transmission mode on antenna ports {0, 1, 2, 3} are inferred from the channels on antenna ports {15, 16, 17, 18} of the associated CSI-RS resource.

29. The method of claim 25 further comprising, for purposes of computing the CQI during the fallback mode, assuming that PDSCH transmissions received from the eNB on the single DMRS port are equivalent to corresponding symbols transmitted on antenna ports {15, . . . 14+P}, as given by
$$[ \begin{matrix}{y}^{( 15 )} ( i ) \\ ⋮ \\ {y}^{( 14 + P )} ( i )\end{matrix} ] = W ( i ) x ( i ) ,$$
where modulation symbols d^{(q)}(0), . . . , d^{(q)}(M_{symb}^{(q)}−1) for codeword q are mapped onto the layers x(i)=[x⁽⁰⁾(i) . . . x^{(ν-1)}(i)]^{T}, i=0, 1, . . . , M_{symb}^{layer}−1, where ν is the number of layers and M_{symb}^{layer} is the number of modulation symbols per layer, Pε{1,2,4,8} is the number of antenna ports of the associated CSI-RS resource, and W(i) is a precoding matrix.

30. The method of claim 29 wherein, if P=1, W(i)=1.

31. The method of claim 29 wherein, if P>1, W(i) is a precoding matrix selected by the UE.

32. The method of claim 29 wherein, if P>1, W(i) is a predefined precoding matrix.

33. A user equipment (UE) for operating in an LTE (Long Term Evolution) network, comprising:
processing circuitry and a radio interface for communicating with an evolved Node B (eNB) wherein the processing circuitry is to:
communicate with an evolved Node B (eNB) over a New Carrier Type (NCT), wherein the NCT has a reduced density of cell-specific reference signals (CRSs) as compared with a legacy carrier;
receive grants of physical downlink shared channel (PDSCH) resources via control channel signaling with DCI (downlink control information) format 2C;
report to the eNB channel state information (CSI) that includes a channel quality indication (CQI) but includes neither a precoding matrix indication (PMI) nor a rank indication (RI);
upon receiving a PDSCH grant from the eNB using DCI format 1A to indicate a fallback transmission mode with transmission of the PDSCH over a single DMRS (demodulation reference signal) port, transmit a CQI to the eNB based upon CSI-RS (channel state information reference signal) resources contained in the NCT.

34. The UE of claim 33 wherein, for purposes of computing the CQI during the fallback mode if the number of antenna ports of the associated CSI-RS resource is one, the processing circuitry is to assume that PDSCH transmissions are on a single DMRS port with the channel on the DMRS port being inferred from the channel on antenna port {15} of the associated CSI-RS resource.

35. The UE of claim 33 wherein, for purposes of computing the CQI during the fallback mode if the number of antenna ports of the associated CSI-RS resource is two, the processing circuitry is to assume that PDSCH transmissions are received from the eNB using a transmit diversity transmission mode where the channels of the transmit diversity transmission mode are inferred from the channels on antenna ports {15, 16} of the associated CSI-RS resource.

36. The UE of claim 33 wherein, for purposes of computing the CQI during the fallback mode if the number of antenna ports of the associated CSI-RS resource is four, the processing circuitry is to assume that PDSCH transmissions are received from the eNB using a transmit diversity transmission mode where the channels of the transmit diversity transmission mode on antenna ports {0, 1, 2, 3} are inferred from the channels on antenna ports {15, 16, 17, 18} of the associated CSI-RS resource.

37. The UE of claim 33 wherein, for purposes of computing the CQI during the fallback mode, the processing circuitry is to assume that PDSCH transmissions received from the eNB on the single DMRS port are equivalent to corresponding symbols transmitted on antenna ports {15, . . . 14+P}, as given by
$$[ \begin{matrix}{y}^{( 15 )} ( i ) \\ ⋮ \\ {y}^{( 14 + P )} ( i )\end{matrix} ] = W ( i ) x ( i ) ,$$
where modulation symbols d^{(q)}(0), . . . , d^{(q)}(M_{symb}^{(q)}−1) for codeword q are mapped onto the layers x(i)=[x⁽⁰⁾(i) . . . x^{(ν-1)} (i)]^{T}, i=0, 1, . . . , M_{symb}^{layer}−1, where ν is the number of layers and M_{symb}^{layer} is the number of modulation symbols per layer, Pε{1,2,4,8} is the number of antenna ports of the associated CSI-RS resource, and W(i) is a precoding matrix.

38. The UE of claim 37 wherein, if P=1, W(i)=1.

39. The UE of claim 37 wherein, if P>1, W(i) is a precoding matrix selected by the UE.

40. The UE of claim 37 wherein, if P>1, W(i) is a predefined precoding matrix.

41. An evolved Node B (eNB) for operating in an LTE (Long Term Evolution) network, comprising:
processing circuitry and a radio interface for communicating with a user equipment (UE), wherein the processing circuitry is to:
communicate with the UE over a New Carrier Type (NCT), wherein the NCT has a reduced density of cell-specific reference signals (CRSs) as compared with a legacy carrier;
transmit grants of physical downlink shared channel (PDSCH) resources via control channel signaling with DCI (downlink control information) format 2C;
configure the UE to report channel state information (CSI) that includes a channel quality indication (CQI) but includes neither a precoding matrix indication (PMI) nor a rank indication (RI);
if a PDSCH grant is transmitted to the UE using DCI format 1A to indicate a fallback transmission mode, transmit the PDSCH over a single DMRS (demodulation reference signal) port, and assume that the CQI received from the UE is based upon CSI-RS (channel state information reference signal) resources contained in the NCT.

42. The eNB of claim 41 wherein the processing circuitry is to assume that the UE, for purposes of computing the CQI during the fallback mode if the number of antenna ports of the associated CSI-RS resource is one, assumes that PDSCH transmissions are on a single DMRS port with the channel on the DMRS port being inferred from the channel on antenna port {15} of the associated CSI-RS resource.

43. The eNB of claim 41 wherein the processing circuitry is to assume that the UE, for purposes of computing the CQI during the fallback mode if the number of antenna ports of the associated CSI-RS resource is two, assumes that PDSCH transmissions are received from the eNB using a transmit diversity transmission mode where the channels of the transmit diversity transmission mode are inferred from the channels on antenna ports {15, 16} of the associated CSI-RS resource.

44. The eNB of claim 41 wherein the processing circuitry is to assume that the UE, for purposes of computing the CQI during the fallback mode if the number of antenna ports of the associated CSI-RS resource is four, assumes that PDSCH transmissions are received from the eNB using a transmit diversity transmission mode where the channels of the transmit diversity transmission mode on antenna ports {0, 1, 2, 3} are inferred from the channels on antenna ports {15, 16, 17, 18} of the associated CSI-RS resource.

45. The eNB of claim 41 wherein the processing circuitry is to assume that the UE, for purposes of computing the CQI during the fallback mode, assumes that PDSCH transmissions received from the eNB on the single DMRS port are equivalent to corresponding symbols transmitted on antenna ports {15, . . . 14+P}, as given by
$$[ \begin{matrix}{y}^{( 15 )} ( i ) \\ ⋮ \\ {y}^{( 14 + P )} ( i )\end{matrix} ] = W ( i ) x ( i ) ,$$
where modulation symbols d^{(q)}(0), . . . , d^{(q)}(M_{symb}^{(q)}−1) for codeword q are mapped onto the layers x(i)=[x⁽⁰⁾(i) . . . x^{(ν-1)}(i)]^{T}, i=0, 1, . . . , M_{symb}^{layer}−1, where ν is the number of layers and M_{symb}^{layer} is the number of modulation symbols per layer, Pε{1,2,4,8} is the number of antenna ports of the associated CSI-RS resource, and W(i) is a precoding matrix.

46. The eNB of claim 45 wherein, if P=1, W(i)=1.

47. The eNB of claim 45 wherein, if P>1, W(i) is a precoding matrix selected by the UE.

48. The eNB of claim 45 wherein, if P>1, W(i) is a predefined precoding matrix.
